(19) United States
(12) Patent Application Publication
(10) Pub. No.: US 2018/0101713 A1
(43) Pub. Date: Apr. 12, 2018

(54) FINGERPRINT SENSOR AND FINGERPRINT RECOGNITION METHOD THEREOF

(71) Applicant: MStar Semiconductor, Inc., Hsinchu Hsien (TW)

(72) Inventor: Hu-Chi Chang, Hsinchu County (TW)

(21) Appl. No.: 15/720,591

(22) Filed: Sep. 29, 2017

(30) Foreign Application Priority Data
Oct. 7, 2016 (TW) 105132475

(51) Int. Cl. G06K 9/00; G06F 3/041

(52) U.S. Cl. CPC G06K 9/0002; G06K 9/00067; G06F 3/0418

(57) ABSTRACT

A fingerprint sensor and a fingerprint recognition method thereof are provided. A fingerprint is detected by a plurality of unit groups to generate a plurality of first signal values. Each of the unit groups includes a plurality of sensing units corresponding to the same driving electrode. It is determined whether noise interference exists. When it is determined that the noise interference exists, the first signal values generated by at least a part of the sensing units are accordingly adjusted to obtain a plurality of second signal values.

This application claims the benefit of Taiwan application Ser. No. 105132475, filed Oct. 7, 2016, the subject matter of which is incorporated herein by reference.

### BACKGROUND OF THE INVENTION

### Field of the Invention

The invention relates in general to a fingerprint sensor and a fingerprint recognition method thereof, and more particularly, to fingerprint sensor and a fingerprint recognition method thereof for reducing noise interference.

### Description of the Related Art

Methods for obtaining data are becoming more diversified as the technology continues progressing in the recent years, making the safekeeping of personal private data more and more challenging. In a conventional privacy protection method, a password is adopted for safeguarding. However, when a password is used for identity verification, the password may be easily leaked or cracked and a user may forget such password, thus again causing numerous inconveniences. In response, biological identification technologies have developed. Through unique human biological characteristics, e.g., fingerprints, irises or voices, the identity of a user can be verified. Regarding the above, fingerprint images are easy to acquire, and a multiplicity property is provided by all ten fingers that can be registered and verified. Further, fingerprint sensors feature advantages of having a small volume and high performance, and are widely received by users. Therefore, fingerprint recognition has become highly valued and gradually applied in versatile consumer electronic products.

Among current fingerprint recognition technologies, a capacitive fingerprint sensor is most common as it can be integrated with an integrated circuit and is readily packaged. A conventional capacitive fingerprint sensor is formed by strip-like driving electrodes and strip-like sensing electrodes, which intersect to form sensing units. A complete fingerprint image may be obtained through sensing ridges and valleys of fingerprints and capacitance changes of the sensing units. However, because height differences between ridges and valleys of a fingerprint are extremely small, the capacitance changes sensed by the sensing units are also minute. As such, external noises can have a significant impact on the capacitance changes detected by the sensing units. More particularly, noise affects only the sensing units that simultaneously perform detection, in a way that the sensing units performing detection at different time points generate signal values affected by noise interface and signal values unaffected by noise interference, resulting in excessively large differences in the signal values with respect to sensing units at different positions. Therefore, a fingerprint image converted from such signal values is not entirely correct, e.g., intersections of dark patterns and bright patterns are susceptible to jagged edges, making characteristics points indistinct, or even bright patterns may exist amidst dark patterns, as shown in FIG. 1. As a result, misjudgment occurs when a fingerprint sensor performs fingerprint matching, and the accuracy of fingerprint recognition is reduced.

### SUMMARY OF THE INVENTION

It is a primary object of the present invention to provide a fingerprint sensor and a fingerprint recognition method thereof to reduce noise interference and enhance the accuracy of fingerprint recognition.

To achieve the above object, the present invention provides a fingerprint recognition method of a fingerprint sensor. The fingerprint sensor includes a sensing element, a control circuit, a noise detection circuit and a computation circuit. The sensing element includes a plurality of driving electrodes and a plurality of sensing electrodes. Each of the driving electrodes and one corresponding sensing electrode intersect to form a sensing unit. The fingerprint recognition method includes following steps. The control circuit detects a fingerprint by a plurality of unit groups to generate a plurality of first signal values. Each of the unit groups includes a plurality of sensing units corresponding to the same driving electrode. The noise detection circuit determines whether noise interference exists. When the noise detection circuit determines that the noise interference exists, the computation circuit accordingly adjusts the first signal values generated by at least a part of the sensing units to obtain a plurality of second signal values.

To achieve the above object, the present invention provides a fingerprint sensor including a sensing unit, a control circuit, a noise detection circuit and a computation circuit. The sensing element detects a fingerprint, and includes a plurality of driving electrodes and a plurality of sensing electrodes. Each of the driving electrodes and one corresponding sensing electrode intersect to form a sensing unit. The sensing unit is divided into a plurality of unit groups, each of which includes a plurality of sensing units corresponding to the same driving electrode. The control circuit is electrically connected to the sensing unit, and detects a fingerprint through the unit groups to generate a plurality of first signal values. The noise detection circuit is electrically connected to the control circuit and the sensing element, and determines by using the sensing units whether noise interference exists. The computation circuit is electrically connected to the control circuit. When the noise detection circuit determines that the noise interference exists, the computation circuit accordingly adjusts the first signal values generated by at least a part of the sensing units to obtain a plurality of second signal values.

In the fingerprint recognition method of a fingerprint sensor of the present invention, corresponding correlation values are respectively subtracted through the first signal values, such that the second signal values obtained from each unit group are located on the same horizontal level, preventing specific unit groups affected by the noise interference and other unit groups unaffected by the noise interference from generating signal values with excessively large differences to improve the issue of intersections of dark patterns and bright patterns being susceptible to jagged edges, and making characteristic points more distinct. Thus, misjudgment of the fingerprint sensor can be reduced to enhance the accuracy of fingerprint recognition.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a fingerprint image detected by a conventional fingerprint sensor;

FIG. 2 is a block diagram of a fingerprint sensor according to an embodiment of the present invention;

FIG. 3 is a top view of a sensing element according to an embodiment of the present invention;

FIG. 4 is a flowchart of a fingerprint recognition method of a fingerprint sensor according to a first embodiment of the present invention;

FIG. 5 is a schematic diagram of a fingerprint sensor generating first signal values according to an embodiment of the present invention;

FIG. 6 is a schematic diagram of sub-frame data according to an embodiment of the present invention;

FIG. 7 is a schematic diagram of first signal values detected by sensing units of different unit groups in one single detection;

FIG. 8 is a diagram of a relationship between second signal values and corresponding unit groups of the present invention;

FIG. 9 is a top view of a fingerprint sensor according to an embodiment of the present invention;

FIG. 10 is a fingerprint image corresponding to fingerprint data according to an embodiment of the present invention;

FIG. 11 is a flowchart of a fingerprint recognition method of a fingerprint sensor according to a second embodiment of the present invention;

FIG. 12 is a diagram of a relationship between image quality and the frequency of noise with respect to an original fingerprint image with noise, a fingerprint image processed by Gaussian blur, and a fingerprint image generated by a fingerprint recognition method of the present invention.

### DETAILED DESCRIPTION OF THE INVENTION

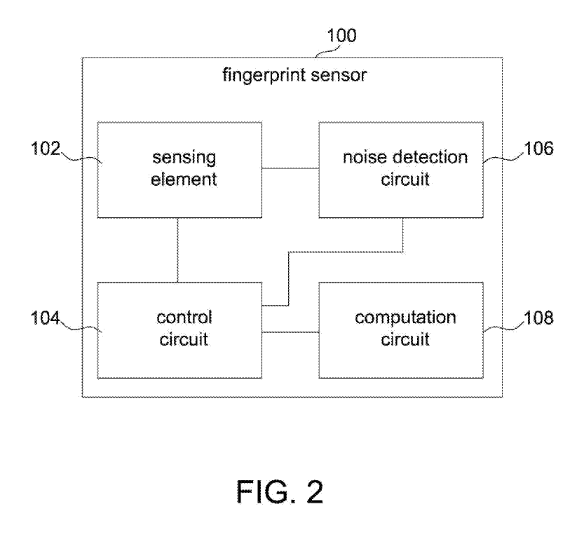

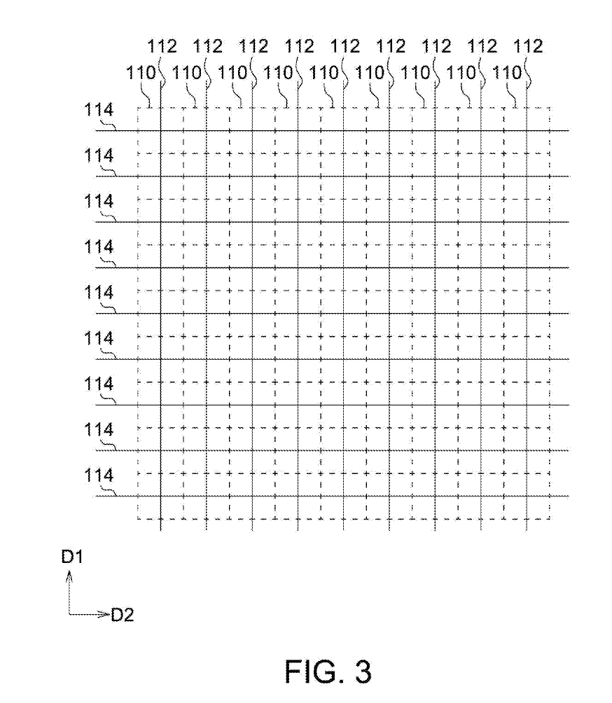

FIG. 2 shows a block diagram of a fingerprint sensor according to an embodiment of the present invention. FIG. 3 shows a top view of a sensing element according to an embodiment of the present invention. As shown in FIG. 2, a fingerprint sensor 100 of this embodiment may include a sensing element 102, a control circuit 104, a noise detection circuit 106 and a computation circuit 108. The sensing unit 102 detects an image of ridges and valleys of a fingerprint. The control circuit 104, electrically connected to the sensing unit 102, transmits a driving signal to the sensing element 102, and receives a sensing signal from the sensing unit 102 to obtain the image of the fingerprint. The noise detection circuit 106, electrically connected to the sensing element 102, detects external noise through the sensing unit 102. Further, the control circuit 104 can also control the noise detection circuit 106 to perform detection on external noise. The computation circuit 108, electrically connected to the control circuit 104, further computes the sensing signal the control circuit 104 receives.

As shown in FIG. 3, in this embodiment, the sensing element 102 may include a plurality of sensing units 110, which are arranged in an array and are for detecting capacitances that ridges and valleys of a fingerprint generate on the sensing units 110. More specifically, the sensing element 102 may be a mutual capacitive sensing element, and includes a plurality of driving electrodes 112 and a plurality of sensing electrodes 114. The driving electrodes 112 extend along a first direction D1, and the sensing electrodes 114 extend along a second direction D2, such that the driving electrodes 112 and the sensing electrodes 114 intersect and are capacitively coupled, and each of the driving electrodes 112 and one corresponding sensing electrode 114 form one sensing unit 110.

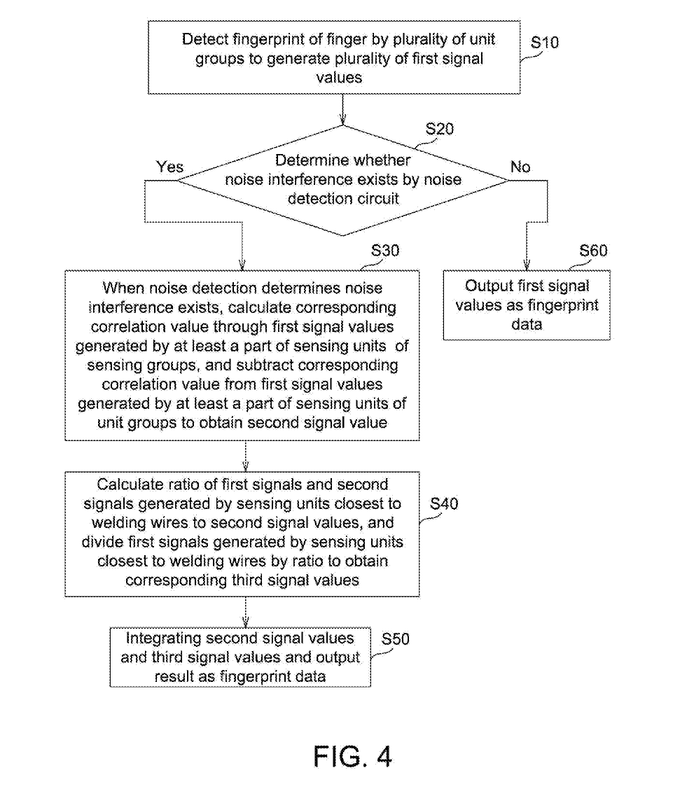

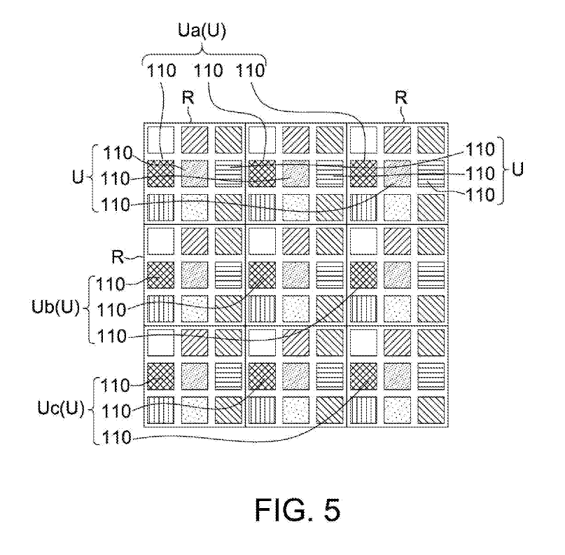

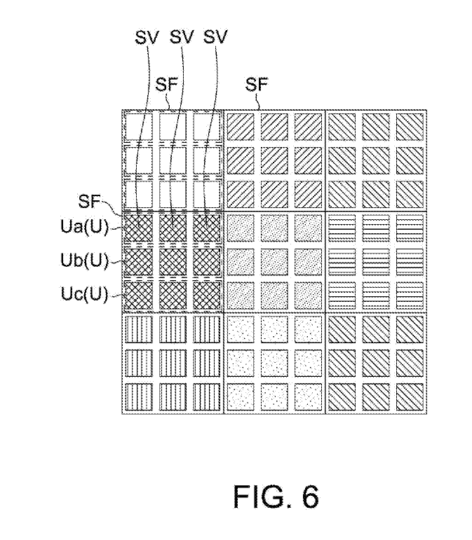

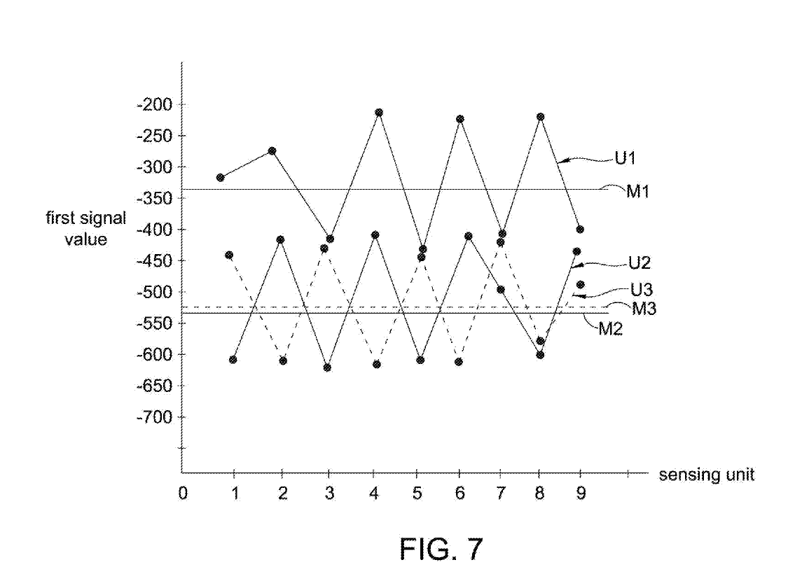

According to the above fingerprint sensor 100, a fingerprint recognition method for reducing noise interference is further provided by the embodiment. Refer to FIG. 4 to FIG. 7 as well as FIG. 2 and FIG. 3. FIG. 4 shows a flowchart of a fingerprint recognition method of a fingerprint sensor according to a first embodiment of the present invention. FIG. 5 shows a schematic diagram of the fingerprint sensor generating first signal values according to the first embodiment of the present invention. FIG. 6 shows a schematic diagram of sub-frame data according to the first embodiment of the present invention. FIG. 7 shows a schematic diagram of first signal values detected by sensing units of different unit groups in one single detection. For clear illustrations, FIG. 3 and FIG. 5 depict only 9×9 sensing units 110, but the present invention is not limited thereto. As shown in FIG. 2 to FIG. 4, the fingerprint recognition method of this embodiment includes following steps. In step S10, a fingerprint of a finger is detected by the sensing units 110 to obtain first signal values. In this embodiment, the method for obtaining the first signal values may be as described below. As shown in FIG. 5 and FIG. 6, the sensing unit 110 is divided into a plurality of regions R, and a plurality of detections are sequentially performed to obtain a plurality of sets of sub-frame data SF, each of which includes a plurality of first signal values SV. In FIG. 5 and FIG. 6 of this embodiment, the sensing units 110 corresponding to the same detection in each region R are represented by the same pattern. FIG. 5 shows substantial positions of the sensing units 5, and FIG. 6 shows a result of sequentially arranging the plurality of sets of sub-frame data SF. Comparing FIG. 5 and FIG. 6, it is clear that the sensing units 110 (represented by the same pattern) corresponding to the same detection have the same relative positions in the individual regions R, and the plurality of first signal values SV that the sensing units 110 corresponding to the same detection generate are closely arranged at the relative positions in the located region R (the plurality of first signal values SV generated by the sensing units 110 having the same pattern are closely arranged together). Further, in each detection, the control circuit 104 generates a first signal value SV from at least one sensing unit 110 of each of the regions R, and the generated first signal value SV may form one single set of sub-frame data SF. Further, when different detections are performed, the control circuit 104 retrieves the first signal values SV from different sensing units 110 in each of the regions R. The detections are repeated accordingly until all of the sensing units 110 have generated the first signal values SV, and the first signal values SV corresponding to a complete fingerprint image can be obtained. In another embodiment, the control circuit 104 is not limited to generating the first signal value SV from each region R in each detection, and may also generate the first signal values SV from the sensing units 110 from a part of the regions R.

In this embodiment, the sensing units 110 that generate one single set of sub-frame data SF may be divided into a plurality of unit groups U, each of which includes a plurality of sensing units 110 corresponding to the same driving electrode 112. For example, FIG. 5 depicts three different unit groups

Ua, Ub and Uc. In one detection, the control circuit 104 transmits a plurality of driving signals to the driving electrodes 112 corresponding to the unit groups Ua, Ub and Uc, respectively. Through the capacitance coupling between the sensing electrodes 114 and the driving electrodes 112, the sensing electrodes 114 of the sensing units 110 of the unit groups Ua, Ub and Uc generate corresponding first signal values SV. Because the sensing units 110 of the unit groups Ua, Ub or Uc are located in different regions R, two sensing units 110 of the same unit group Ua, Ub or Uc are non-adjacent, thus preventing signal interference between the sensing units 110 during the detection.

In step S20, whether noise interference exists is determined by the noise detection circuit 106. More specifically, when driving signals are not being transmitted to the driving electrodes 112, the noise detection circuit 106 detects whether noise exists through the sensing electrodes 114. In one embodiment, when noise is generated by the sensing electrodes 114 and the frequency of the noise is the same as the frequency of the driving signals, the noise detection circuit 106 determines that noise exists. For example, the frequency of the driving signals may substantially between 100 kHz and 600 kHz. FIG. 7 shows an example with noise interference. FIG. 7 depicts the first signal values of only three unit groups U1, U2 and U3, each of which may have 9 first signal values to clearly illustrate differences of the first signals of different unit groups. However, the present invention is not limited thereto. Because noise generates interference when the sensing units 110 of one specific unit group performs the detection, an average value M1 of the first signal values generated by the sensing units 110 of the unit group U1 is noticeably different from average values M2 and M3 of the first signal values generated by the sensing units 110 of the unit groups U2 and U3 that are not affected by noise interference. For example, the differences of the average value M1 from the average values M2 and M3 may be approximately 200, wherein the average values M1, M2 and M3 have different physical quantities as calculation methods differ, and are mainly for representing conversion values of actual capacitance values. The average values M1, M2 and M3 may or may not have a unit; for example but not limited thereto, they may include physical quantities such as voltage and capacitance. In another embodiment, the noise detection circuit 106 may also determine that the first signal values generated by the sensing units 110 of at least two unit groups U are affected by noise. In one embodiment, the unit groups U1, U2 and U3 may be of the same detection, i.e., the sensing units 110 that generate the same set of sub-frame data SF. That is to say, the noise detection circuit 106 may use the unit groups U1, U2 and U3 that jointly generate the same set of sub-frame data SF in the same detection as the basis for determining whether the first signal values are affected by noise. Considering that, in a working period of one same detection, the unit groups U1, U2 and U3 are exposed in substantially the same noise environment. Thus, using the first signals obtained by the unit groups U1, U2 and U3 as the basis for determining whether noise interference exists effectively eliminates noise purely generated by the driving signals. Further, using the unit groups U1, U2 and U3 as mutual determination basis is also beneficial for reducing computation resources used by the computation circuit 108 and the noise detection circuit 106.

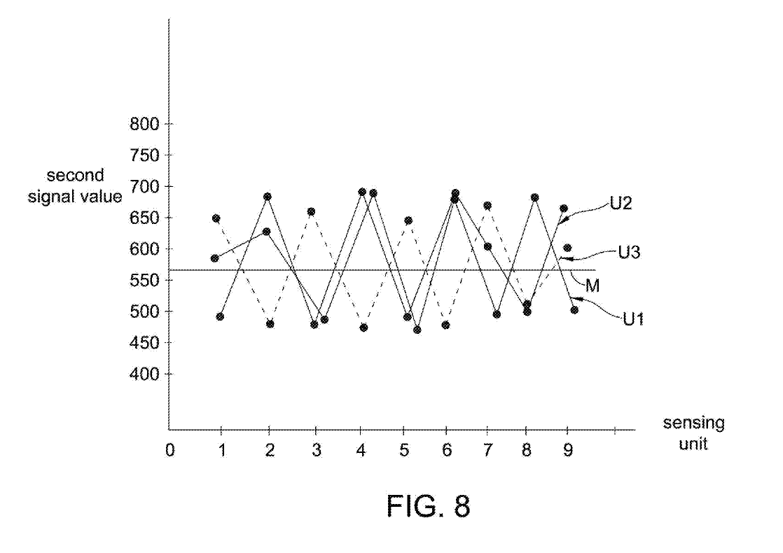

When the noise detection circuit 106 determines that noise interference exists, a correction in step S30 is performed, in which the computation 108 accordingly adjusts the first signal value generated by at least a part of the sensing units 110 of the unit groups U to obtain corresponding second signal values. In one embodiment, a corresponding correlation value is calculated through the first signal value generated by each of at least a part of the sensing units 110 of the unit groups U, and the computation circuit 108 subtracts the corresponding correlation value from the first signal value generated by each of at least a part of the sensing units 110 of the unit groups U to generate a corresponding second signal value. In another embodiment, the computation circuit 108 adjusts only the first signal values generated by at least a part of the sensing units 110 of the unit groups U determined as having been interfered, and subtracts or adds a difference between the correlation value and a correlation value corresponding to other unit groups U that are not interfered to those first signal values, and uses these results and other non-adjusted first signal values as a plurality of second signal values. FIG. 8 shows a schematic diagram of a relationship between second signal values and a corresponding unit group of the present invention. As shown in FIG. 8, in this embodiment, for example but not limited to, the correlation values may be average values of the first signal values corresponding to the unit groups U1, U2 and U3, respectively. In another embodiment, the correlation values may each be a minimum value or a maximum value of the first signal values of the corresponding unit group. It should be noted that, through the correction, the average values M of the unit groups U1, U2 and U3 may be made equal and locate on the same horizontal level, so as to prevent a specific unit group U1, due to being affected by noise interference, from generating signal values that excessively differ from those generated by other non-interfered unit groups U2 and U3, thus improving the issue that intersections between dark patterns and bright patterns are susceptible to jagged edges. Further, characteristic points can become more distinct to further enhance the accuracy of fingerprint recognition. In another embodiment, to more precisely eliminate other noises, all of the first signal values generated in the same detection (i.e., all of the first signal values generated by the unit groups U1, U2 and U3) or the second signal values generated in the same detection may be summed to generate a fourth signal value. The fourth signal values from different detections are compared to determine whether interference exists during a working period of one single detection, and all of the first signal values or the second signal values generated in one interference detection are uniformly adjusted accordingly. Alternatively, all of the first signal values or second signal values generated in one detection affected by interference are deleted. Alternatively, after it is determined that the working period of one single detection is interfered by noise, the correction of step S30 is applied to adjust all of the first signal values or second signal values generated from different detections.

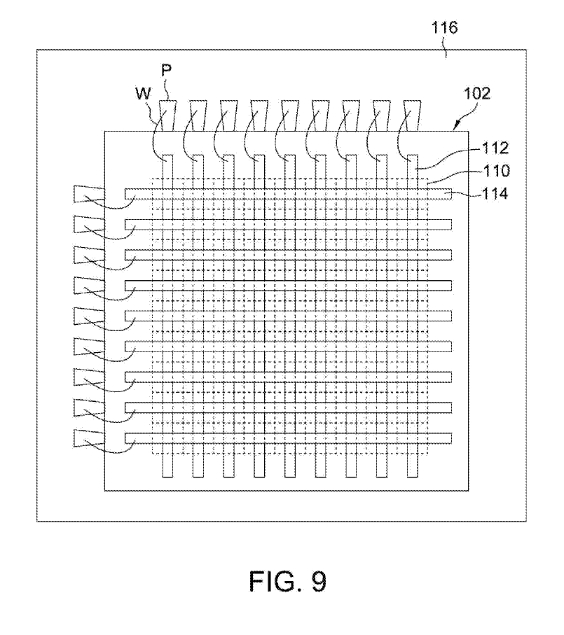

For example, FIG. 9 shows a top view of a fingerprint sensor according to an embodiment of the present invention. As shown in FIG. 9, when a package of the fingerprint sensor 100 is manufactured via a redirection layer (RDL) process, the fingerprint sensor 100 may further include a plurality of welding wires W, which are respectively connected to end points of the driving electrodes 112 and end points of the sensing electrodes 114. More specifically, the welding wires W electrically connect the driving electrodes 112 and the sensing electrodes 114 to pads P on a circuit board 116 to accordingly electrically connect to a control circuit (not shown). The control circuit may be disposed right below the driving electrodes 112 and the sensing electrodes 114.

In this situation, as the structure of connecting positions of the welding wires W with the driving electrodes 112 and the sensing electrodes 114 affects the first signal values detected by the sensing units 110 and thus distort the first signal values, the control circuit may exclude the affected first signal values in advance. That is, the step of calculating the correlation values includes excluding the first signal values generated by the sensing units 110 closest to the welding wires W, so that, from the unit groups, the part of the sensing units 110 used for calculating the correlation values does not include the sensing units 110 closest to the welding wires W.

Referring to FIG. 2 to FIG. 4, step S40 is then performed. After the step of subtracting the corresponding correlation values from the first signal values generated by a least a part of the sensing units of the unit groups U, the computation circuit 108 calculates a ratio of the first signal value generated by the sensing units 110 closest to the welding wires W to a second signal value. For example, the computation circuit 108 calculates a ratio of the first signal values generated by the excluded sensing units to the second signal values of the adjacent sensing units 110, and divides each of the first signal values generated by the sensing units 110 closest to the welding wires W by the corresponding ratio to obtain a corresponding third signal value.

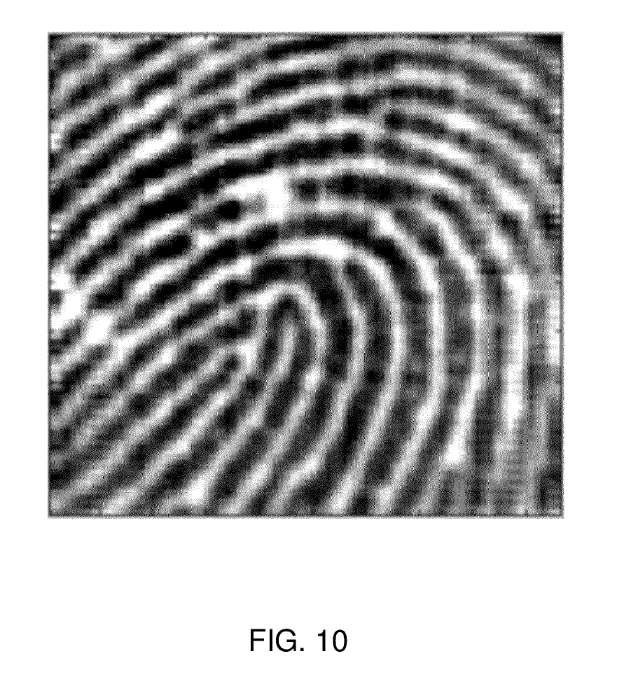

Step S50 is then performed. In step S50, the third sensing values of the excluded sensing units 110 are integrated with the second signal values of the sensing units 110 used for calculating the correlation values, and each of the third signal values and each of the second signal values are then arranged according to the positions of the corresponding sensing units to output a result as the fingerprint data. FIG. 10 shows a fingerprint image corresponding to the fingerprint data of the embodiment. As shown in FIG. 10, the complete fingerprint image can be displayed according to the corresponding fingerprint data. It should be noted that, compared to a conventional fingerprint image in

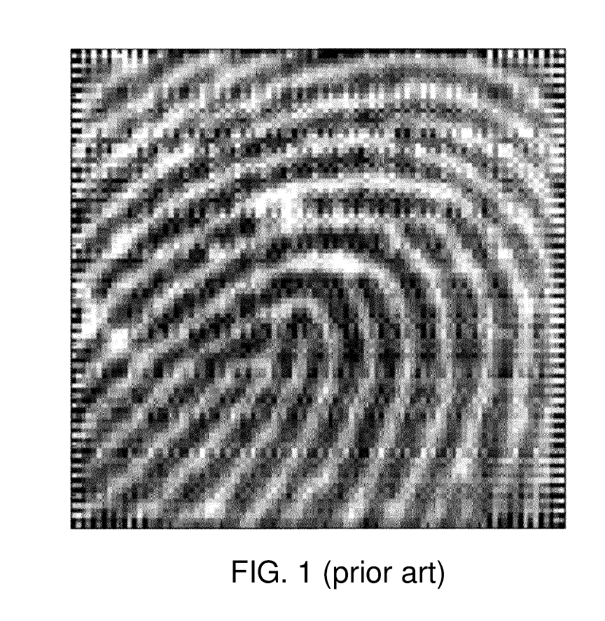

FIG. 1, in the fingerprint recognition method of the embodiment, the corresponding correlation value is subtracted from each first signal value, such that the second signal values of each unit group can locate on the same horizontal level, thus preventing specific unit groups affected by the noise interference and other unit groups unaffected by the noise interference from generating signal values with excessively large differences, and making characteristic points more distinct. As such, misjudgment of the fingerprint sensor 100 can be reduced to enhance the accuracy of fingerprint recognition.

Further, the fingerprint recognition method of the embodiment further excludes the first signal values detected by the structurally defective sensing units, and so the calculation of the correlation values is prevented from being affected by incorrect first signal values and shifts in the correlation values are reduced, thereby further enhancing the accuracy of the second signal values.

Further, when the noise detection circuit determines that noise interference does not exist in step S20, step S60 is performed, to directly arrange the first signal values according to the positions of the corresponding sensing units 110, and the result is outputted as the fingerprint data having a complete fingerprint image.

The fingerprint recognition method of a fingerprint sensor of the present invention is not limited to the above embodiments. To better compare differences among the embodiments and to keep description simple, the same denotations are used to represent the same elements in the embodiments and the variations of the embodiments below.

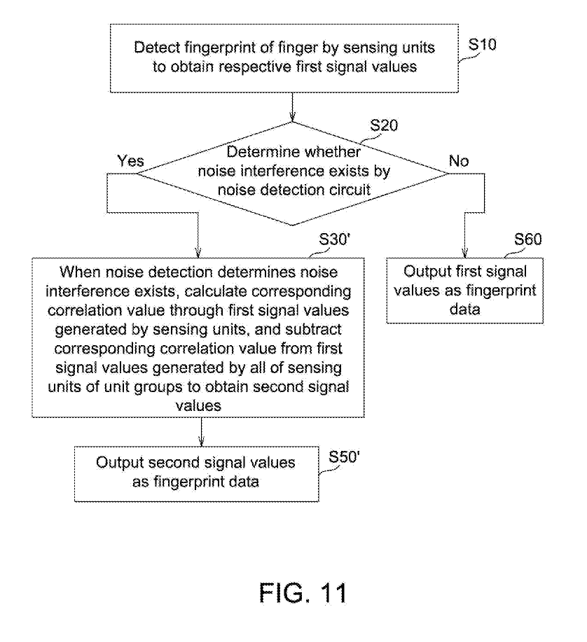

FIG. 11 shows a flowchart of a fingerprint recognition method of a fingerprint sensor according to a second embodiment of the present invention. As shown in FIG. 1, FIG. 2 and FIG. 11, compared to the first embodiment, the fingerprint sensor 100 of this embodiment may be manufactured via different packaging methods. Thus, there are no connections between the end points of the driving electrodes 112 and the end points of the sensing electrodes 114, and the first signal values detected by the sensing units 110 are free from the issue of distortion. When step S30′ of this embodiment is performed, the computation circuit 108 calculates the correlation values through the first signal values generated by all of the sensing units 110 of the unit groups, respectively, and subtracts the corresponding correlation values from the first signal values generated by all of the sensing units 110 of the unit groups to obtain corresponding second signal values, respectively. Further, without performing step S40, the fingerprint sensor 100 directly performs step S50′ to arrange the second signal values according to the positions of the corresponding sensing units 110, and output fingerprint data having a complete fingerprint image. Steps S10, S20 and S60 of this embodiment are identical to those in the first embodiment, and shall be omitted for brevity.

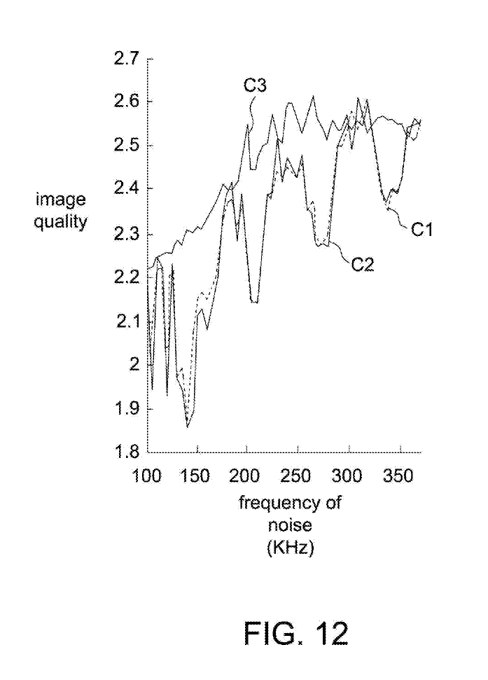

Referring to FIG. 12 and Table-1, FIG. 12 shows a diagram of a relationship between image quality of an original fingerprint image with noise, a fingerprint image processed by Gaussian blur and a fingerprint image generated by the fingerprint recognition method of the present invention and the noise frequency; Table-1 shows false accept rate (FAR) and false reject rate (FRR) of an original fingerprint image with noise, a fingerprint image processed by Gaussian blur and a fingerprint image generated by the fingerprint recognition method of the present invention. As shown in FIG. 12, the curves C1, C2 and C3 respectively represent relationship curves of the image quality of a fingerprint image of an original fingerprint image with noise, a fingerprint image processed via Gaussian blur and a fingerprint image generated by the fingerprint recognition method of the present invention and the noise frequency. The definition of image quality is a comparison difference between a fingerprint image affected by noise and a fingerprint image unaffected by noise, and the frequencies of applied noise are respectively located at 140 MHz, 210 MHz, 275 MHz and 345 MHz. It should be noted that, the image quality of a fingerprint image generated by the above embodiments of the present invention corresponding to the frequencies with noise is not noticeably reduced, and is obviously not affected by noise. In contrast, the image quality of the original image fingerprint with noise and the fingerprint image processed via Gaussian blur corresponding to the frequencies with noise is significantly reduced. Therefore, the fingerprint image generated by the above embodiments of the present invention effectively reduces noise interference and enhances the image quality of the fingerprint image. Further, as shown in Table-1, when the false accept rate (FAR) is 1/50000, the false reject rate (FRR) of the fingerprint image processed via Gaussian blur is 3.63, which is higher than the false reject rate (FRR) 3.83 of the original fingerprint image with noise. The false accept rate (FAR) is defined as the probability of misjudging a fingerprint image of another object as a fingerprint image of an actual target, and the false reject rate is defined as the probability of misjudging a fingerprint of an actual target as a fingerprint image of another object. Thus, the Gaussian blur process is ineffective in mitigating noise interference, and contrarily increases the false reject rate (FRR). In contrast, in a situation where the false accept rate (FAR) 1/50000, the false reject rate (FRR) of a fingerprint image generated via the fingerprint recognition method of the present invention is 3.06, which is apparently lower than the false reject rate of the original fingerprint image with noise. Therefore, the present invention effectively lowers the false reject rate (FRR) of fingerprint images and mitigates noise interference.

TABLE 1

| | False reject | | False reject rate |
|---|---|---|---|
| | rate (FRR) | | (FRR) of fingerprint |
| False | of original | False reject rate | image generated by |
| accept | fingerprint | (FRR) of fingerprint | fingerprint recognition |
| rate | image with | image processed by | method of present |
| (FAR) | noise | Gaussian blur | invention |
| 1/50000 | 3.38 | 3.63 | 3.06 |
| 1/10000 | 2.74 | 3.14 | 2.58 |
| 1/5000 | 2.66 | 3.14 | 2.42 |
| 1/1000 | 2.42 | 2.50 | 2.26 |
| 1/500 | 2.10 | 2.26 | 2.10 |
| 1/100 | 1.85 | 1.85 | 1.69 |
| 1/50 | 1.69 | 1.69 | 1.53 |
| 1/10 | 0.89 | 1.23 | 1.05 |
| 1/5 | 0.73 | 0.73 | 0.89 |
| 1/1 | 0.00 | 0.00 | 0.00 |

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fingerprint recognition method of a fingerprint sensor, the fingerprint sensor comprising a sensing element, a control circuit, a noise detection circuit and a computation circuit, the sensing element comprising a plurality of driving electrodes and a plurality of sensing electrodes, each of the driving electrodes and one corresponding sensing electrodes intersecting and forming a sensing unit, the fingerprint recognition method comprising:
detecting a fingerprint by the control circuit through a plurality of unit groups to generate a plurality of first signal values, each of the unit groups comprising the plurality of sensing units corresponding to the same driving electrodes;
determining whether noise interference exists by the noise detection circuit; and
when the noise detection circuit determines that the noise interference exists, accordingly adjusting the first signal values generated by at least a part of the sensing units by the computation circuit to obtain a plurality of second signal values.

2. The fingerprint recognition method of a fingerprint sensor according to claim 1, wherein the computation circuit calculates a corresponding correlation value through the first signal values generated by the at least one part of sensing units of the unit groups, and each of the correlation values is one of an average value of the first signal values generated by the at least a part of the sensing units of one corresponding unit group, and a minimum value or a maximum value of the first signal values generated by the at least a part of the sensing units of one corresponding unit group.

3. The fingerprint recognition method of a fingerprint sensor according to claim 1, wherein two of the sensing units of the same unit group are non-adjacent.

4. The fingerprint recognition method of a fingerprint sensor according to claim 1, wherein the noise detection circuit utilizes the first signal values generated by the at least a part of the sensing units of the unit group of a same detection as a basis for determining whether the noise interference exists.

5. The fingerprint recognition method of a fingerprint sensor according to claim 1, further comprising summing the first signal values generated by the at least a part of the sensing units of the unit groups of one single detection to generate a plurality of fourth signal values, and comparing the fourth signal values to accordingly adjust the first signal values generated by the at least a part of the sensing units of the unit groups of one single detection.

6. The fingerprint recognition method of a fingerprint sensor according to claim 1, further comprising summing the second signal values generated by the at least a part of the sensing units of the unit groups of one single detection to generate a plurality of fourth signal values, and comparing the fourth signal values to accordingly adjust the second signal values generated by the at least a part of the sensing units of the unit groups of one single detection.

7. The fingerprint recognition method of a fingerprint sensor according to claim 1, wherein the fingerprint sensor comprises a plurality of welding wires respectively connected to end points of the driving electrodes and end points of the sensing electrodes, and the computation circuit adjusts the first signal values generated by at least a part of the sensing units according to the corresponding correlation values and further excludes the first signal values generated by the sensing units closest to the welding wires to obtain the plurality of second signal values.

8. The fingerprint recognition method of a fingerprint sensor according to claim 7, after the computation circuit obtains the plurality of second signal values, further calculates a ratio of the first signal value generated by each of the sensing units closest to the welding wires to one of the second signal values, divides the first signal value generated by each of the sensing units closest to the welding wires by the corresponding ratio to obtain a corresponding third signal value, and integrates the third signal values and the second signal values to output fingerprint data.

9. The fingerprint recognition method of a fingerprint sensor according to claim 1, wherein the computation circuit calculates corresponding correlation values through the first signal values generated by all of the sensing units of the unit groups, respectively, and subtracts the corresponding correlation value from the first signal value generated by each of the sensing units of the unit groups to obtain the corresponding second signal value.

10. The fingerprint recognition method of a fingerprint sensor according to claim 9, further comprising outputting the second signal values as fingerprint data after obtaining the second signal values.

11. The fingerprint recognition method of a fingerprint sensor according to claim 1, wherein the first signal values are outputted as fingerprint data when the noise detection circuit determines that the noise interference does not exist.

12. The fingerprint recognition method of a fingerprint sensor according to claim 1, wherein the step of generating the first signal values comprises transmitting a plurality of driving signals to the driving electrodes of the unit groups, respectively, and generating the first signal values through the sensing electrodes of the unit groups.

13. The fingerprint recognition method of a fingerprint sensor according to claim 12, wherein the step of determining whether the noise interference exists comprises:
detecting whether noise exists by the sensing electrodes when the driving signals are not being transmitted to the driving electrodes; and
determining that the noise interference exists when the sensing electrodes generates the noise.

14. The fingerprint recognition method of a fingerprint sensor according to claim 13, wherein a frequency of the noise is equal to a frequency of the driving signals.

15. The fingerprint recognition method of a fingerprint sensor according to claim 12, wherein a frequency of the driving signals is substantially between 100 KHz and 600 KHz.

16. The fingerprint recognition method of a fingerprint sensor according to claim 1, wherein the computation circuit calculates a corresponding correlation value through the first signal values generated by the at least a part of the sensing units of the unit groups, and subtracts the correlation value from the first signal values generated by the at least one the sensing units of the unit groups to obtain the corresponding second signal values.

17. The fingerprint recognition method of a fingerprint sensor according to claim 1, wherein the computation circuit calculates a corresponding correlation value through the first signal values generated by the at least a part of the sensing units of the unit groups, selectively adds or subtracts a difference between the corresponding correlation value and one corresponding correlation value of the unit group unaffected by interference to or from the first signal values generated the at least a part of the sensing units of the unit groups determined as being affected by interference, and utilizing the results and the other unadjusted first signals as the second signal values.

18. A fingerprint sensor, comprising:
a sensing element, detecting a fingerprint, comprising a plurality of driving electrodes and a plurality of sensing electrodes, each of the driving electrodes and one corresponding sensing electrode intersect and from a sensing unit, wherein the sensing units are divided into a plurality of unit groups, and each unit group comprises the plurality of sensing units corresponding to the same driving electrode;
a control circuit, electrically connected to the sensing element, detecting the fingerprint through the unit groups to generate a plurality of first signal values;
a noise detection circuit, electrically connected to the control circuit and the sensing element, determining whether noise interference exists by the sensing units; and
a computation circuit electrically connected to the control circuit, accordingly adjusting the first signal values generated by at least a part of the sensing units when the noise detection circuit determines that the noise interference exists to obtain a plurality of second signal values.

19. The fingerprint sensor according to claim 17, wherein the computation circuit calculates a corresponding correlation value through the first signal values generated by the at least one part of sensing units of the unit groups, and the correlation value is one of an average value of the first signal values generated by the at least a part of the sensing units of one corresponding unit group, and a minimum value or a maximum value of the first signal values generated by the at least a part of the sensing units of one corresponding unit group.

20. The fingerprint sensor according to claim 16, further comprising a plurality of welding wires respectively connected to end points of the driving electrodes and end points of the sensing electrodes, and the computation circuit excludes the first signal values generated by the sensing units closets to the welding wires when the computation circuit calculates the correlation values.
